(19) United States
(12) Patent Application Publication
(10) Pub. No.: US 2025/0117216 A1
(43) Pub. Date: Apr. 10, 2025

(54) DISTRIBUTED INTELLIGENCE FOR PERFORMANCE AND RESOURCE OPTIMIZATION OF AN APPLICATION

(71) Applicant: Cisco Technology, Inc., San Jose, CA (US)

(72) Inventors: Jieyu Tan, Hangzhou (CN); Zhou Qiang, Hangzhou (CN); Soya Li, Hangzhou (CN); Wallice Wang, Hangzhou (CN); Sijia Chen, Pleasanton, CA (US); Deqiang Ye, Hangzhou (CN)

(21) Appl. No.: 18/484,034

(22) Filed: Oct. 10, 2023

(51) Int. Cl. G06F 8/77

(52) U.S. Cl. CPC G06F 8/77

(57) ABSTRACT

The present technology pertains to a method to balance the performance of an application with the device health and the application runtime health statistics utilizing a hybrid approach. In the hybrid approach, the static performance control is a robust machine learning algorithm trained on data from many client devices and applications. The dynamic performance control is local to the client device and the application and reacts to the real-time device performance and application performance. Additionally, a user can provide their preferences for the performance and resource optimization of the application.

### BACKGROUND

Performance and resource optimization, also known as performance tuning, involves the process of balancing various aspects of an application, such as speed, responsiveness, resource utilization, and overall efficiency. Performance issues, such as slow loading times, lagging response, or excessive resource consumption, can negatively impact user satisfaction, productivity, and even revenue generation. Balancing the performance of an application with resource consumption is a key aspect of performance optimization. It aims to strike the right equilibrium between delivering high-performance capabilities and efficiently utilizing system resources. The goal is to ensure that the application delivers optimal performance while minimizing the consumption of system resources such as CPU, memory, storage, and network bandwidth. By achieving this balance, developers can create efficient software solutions that provide exceptional user experiences while maximizing the utilization of available resources. Achieving performance optimization requires a comprehensive understanding of the application architecture, profiling tools, performance metrics, and optimization techniques. It involves analyzing system bottlenecks, identifying resource-intensive areas, and implementing targeted optimizations to eliminate inefficiencies and improve overall performance.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example system diagram showing the relationship between a static performance control located at a cloud data center and a dynamic performance control that is part of an application running on a client device in accordance with some aspects of the present technology.

FIG. 2 illustrates an example of correlations derived by the static performance control 106 in the example of a video meeting application.

FIG. 3 illustrates an example routine for using a static performance control combined with a dynamic performance control to provide performance and resource optimization in accordance with some aspects of the present technology.

FIG. 4 illustrates an example of a user interface that can be provided to receive user feedback regarding their preferences for the device health and the application runtime health statistics in accordance with some aspects of the present technology.

FIG. 5 illustrates an example of a function of the learning service 110 in accordance with some aspects of the present technology.

FIG. 6 illustrates graphs showing a benefit of the learning service in accordance with some aspects of the present technology.

FIG. 7 illustrates an example lifecycle of a ML model in accordance with some aspects of the present technology.

FIG. 8 illustrates an example of a deep learning neural network that can be used to implement a static performance control, dynamic performance control, or learning service, according to some aspects of the disclosed technology;

FIG. 9 shows an example of a system for implementing some aspects of the present technology.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In one aspect, a method includes receiving, by the application, an output of a static performance control, where the output of the static performance control is initial application configurations for at least one configurable aspect of the application, executing, by a client device, the application using the initial application configurations for the performance of the application, detecting, by the dynamic performance control, feedback regarding device health and application runtime health statistics, and adjusting, by the application, the at least one configurable aspect of the application to deviate from the initial application configurations to account for the feedback regarding the device health and the application runtime health statistics.

The method may also include further includes receiving user feedback by the dynamic performance control regarding the device health and the application runtime health statistics, the user feedback indicating preferences for the device health and the application runtime health statistics and the performance of the application, where the user feedback is the feedback regarding the device health and the application runtime health statistics.

The method may also include receiving feedback from a learning service indicating that the adjusting of the at least one configurable aspect of the application will not be effective on the client device and recover the initial application configurations.

The method may also include where the static performance control includes a cloud-based machine learning algorithm, and where the dynamic performance control includes a machine learning algorithm on the client device.

The method may also include where the adjusting the at least one configurable aspect of the application is to select a reduced performance parameter of the at least one configurable aspect of the application which is correlated to a reduction in device health and the application runtime health statistics. Other technical features may be readily apparent to one skilled in the art from the following figures, descriptions, and claims.

The method may also include further includes updating, by the application, the dynamic performance control based on the user feedback indicating preferences for the device health and the application runtime health statistics and the performance of the application to be applied in a future use of the application.

The method may also include where an adjusting the at least one configurable aspect of the application is to meet the user feedback indicating preferences for the device health and the application runtime health statistics and the performance of the application. Other technical features may be readily apparent to one skilled in the art from the following figures, descriptions, and claims.

### Example Embodiments

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

As used herein the term “configured” shall be considered to interchangeably be used to refer to configured and configurable, unless the term “configurable” is explicitly used to distinguish from “configured”. The proper understanding of the term will be apparent to persons of ordinary skill in the art in the context in which the term is used.

The disclosed technology addresses the need in the art for using a static performance control combined with a dynamic performance control for performance and resource optimization of an application. More specifically the present technology pertains to a method to balance the performance of an application with the device health and the application runtime health statistics utilizing a hybrid approach. In the hybrid approach, the static performance control is a robust machine learning algorithm trained on data from many client devices and applications. The dynamic performance control is local to the client device and the application and reacts to the real-time device performance and application performance. Additionally, a user can provide their preferences for the performance and resource optimization of the application.

Most well-engineered applications take into account some amount of performance and resource optimization in the design of the applications. However, the conscientious design of an application is not enough since it is not possible to predict all aspects of every run-time environment. For example, some devices might have less RAM, or more capable processors, or might be running in an environment with other resource-hungry applications. Therefore, some applications might even include services that monitor system resource consumption and throttle performance aspects of the application to provide a better overall customer experience. After all, a well-designed application can still tax computing resources enough to degrade the performance of the application and other applications running on the same system.

In addition to unpredictable system environments, the users of applications add to the complexity of the performance and resource optimization challenge. To maximize performance, users often attempt to enhance or utilize many resource-hungry application features, leading to the depletion of device resources. Consequently, rather than achieving the desired high-performance experience, they encounter diminished performance.

While the above challenges are relevant to many applications, one type of application where performance and resource optimization is particularly important and challenging is video conferencing applications. Video conferencing applications not only have to deal with resource-hungry video streams and audio streams, both incoming and outgoing but also can have many other resource-hungry features like recorders, facial recognition, transcription, etc. Further, a user's expectation for performance can vary. Some users might require quality audio performance but are willing to accept lower resolution in their video or even choppiness in the video, whereas other users might have less tolerance for degraded video performance.

Current performance and resource optimization tools still leave a lot to be desired because these tools are static. In other words, these performance and resource optimization tools are programmed to respond to system resource levels with pre-programmed performance modifications. These performance and resource optimization tools are generalized to work across many devices but are not optimized for any particular client device. They also are not regularly improved—they might be updated infrequently. And they do not take into account different user's feedback.

The present technology addresses these short-comings by leveraging both a static performance control and a dynamic performance control, which collectively form a distributed artificial intelligence (AI) solution for performance and resource optimization. The static performance control can be big-data based machine learning model that is trained in a cloud datacenter and is used to create an algorithm for the application to deploy during run time to provide initial application configurations that are expected to provide a good user experience that balances performance and resource utilization. The dynamic performance control can be configured to react to changing conditions on the client device using the algorithm provided by the static performance control, and is also configured to reject configuration changes that are not likely to have the desired effect on the client device, and is also configured to receive indications of user preferences regarding performance and resource utilization. Collectively, the static performance control and dynamic performance control provide an approach that is guided by large data, and client device/user specific feedback and data to yield a better customer experience.

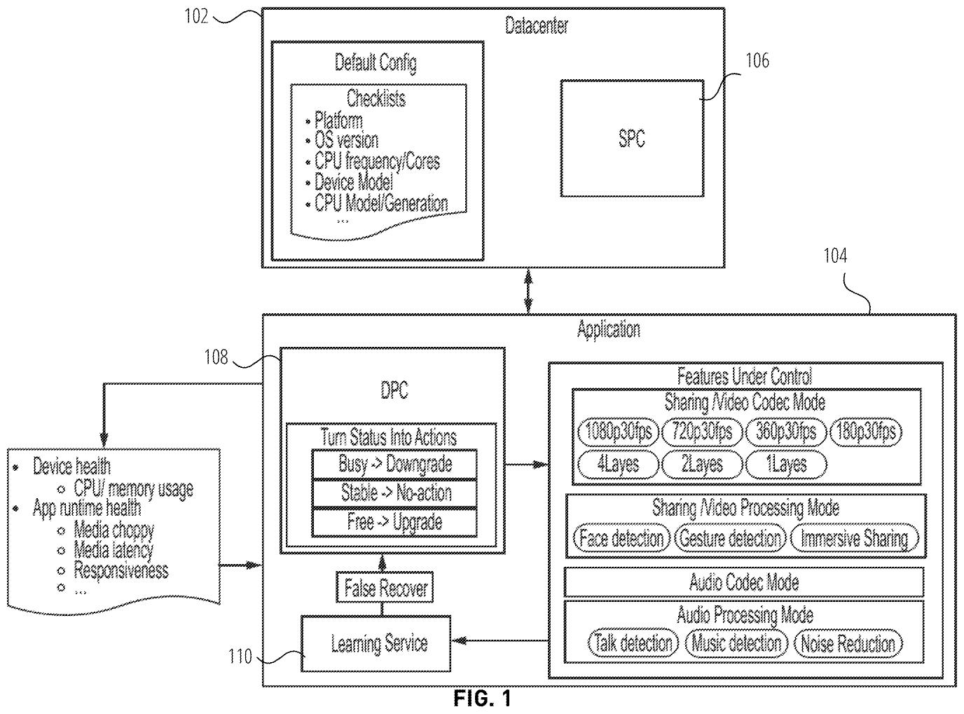

FIG. 1 illustrates an example system diagram showing the relationship between a static performance control located at a cloud data center and a dynamic performance control that is part of an application running on a client device in accordance with some aspects of the present technology. Although the example system depicts particular system components or services and an arrangement of such components and services, this depiction is to facilitate a discussion of the present technology and should not be considered limiting unless specified in the appended claims.

The system illustrated in FIG. 1 includes a static performance control 106 located at datacenter 102. The static performance control 106 can be a machine learning model trained on a large data set comprised of information about client devices running an application and application configurations on respective client devices.

For a particular version of an application running on a particular client device, the static performance control 106 can receive data regarding device attributes of the particular client device such as an operating system version, processor speed and number of cores, device and model, CPU model and generation, etc. The static performance control 106 can also receive device health and the application runtime health statistics from the particular client device, including CPU usage, memory usage, power usage, audio quality statistics, video quality statistics, and sharing quality statistics, among other client device attributes. The static performance control of 106 can also receive information about the configurable attributes of the application, and data regarding adjustments in these configurations and a resulting change in the device health and the application runtime health statistics. The resulting change can be measured or articulated in a convergence time, which represents a time for the device health and the application runtime health statistics to return to an acceptable level after a configuration change.

In the context of a video meeting application, some of configurable attributes of the application can include a video codec used for received video, a video codec used for transmitted video, an audio codec used for transmitted audio, an audio codec used for received audio, video quality parameters (resolution and frames-per-second, layers of video, etc.), video processing features (face detection, gesture detection, immersive sharing, etc.) audio processing features (talk detection, music detection, noise reduction, etc.) among other configurable attributes. FIG. 1 illustrates many of these configurable attributes.

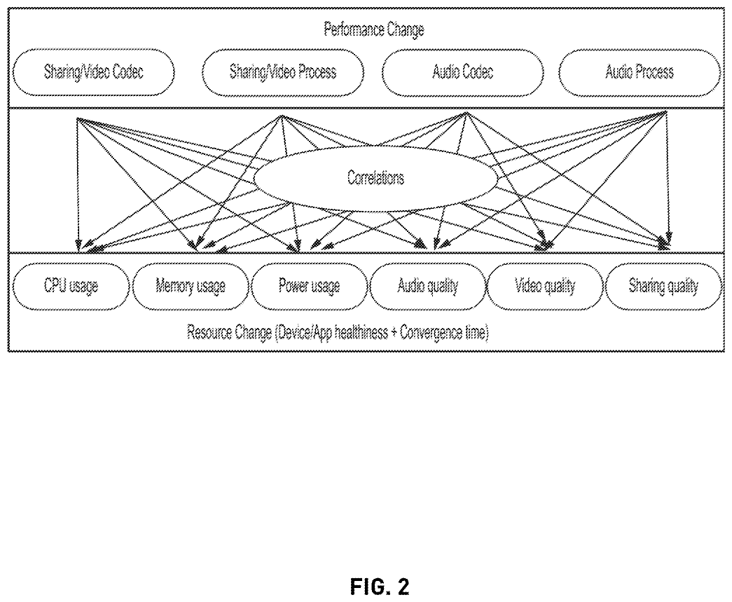

The static performance control 106 can receive information such as that described above from devices that have application 104 installed on them. This amounts to a large collection of data. Using this collection of data, the static performance control 106 can discover correlations between the performance of the application (associated with configurations of application 104) and resource consumption by the client device and can ultimately generate an algorithm for use by application 104 to support performance and resource optimization by application 104 running on their respective client device. FIG. 2 illustrates an example of correlations derived by the static performance control 106 in the example of a video meeting application.

The dynamic performance control 108 is part of application 104 running on a client device. Where the static performance control 106 provides an initial configuration that is designed to be effective on any client device, or at least on any client device having similar device attributes, the dynamic performance control 108 is intended to take into account factors specific to the particular client device and particular runtime data from that client device while application 104 is running.

In particular, the dynamic performance control 108 can monitor the device health and the application runtime health and can make adjustments to configurable features of the application in response to the device health and application runtime health metrics. For example, when the device health or application health runtime health metrics indicate that the system is overloaded according to one or more parameters, the dynamic performance control 108 can downgrade one or more configurable features of the application. Or if device resources remain idle, the dynamic performance control 108 can upgrade one or more configurable features of the application.

The dynamic performance control 108 can also take into account user preferences. For example, a user can give feedback regarding their satisfaction with the performance of application 104. In particular, the user may interact with a user interface that can inform learning service 110 of these user preferences. These user preferences may indicate that some configurable features of the application are more important to the user than others and in situations in which the dynamic performance control 108 might need to downgrade one or more features of the application learning service 110 can instruct the dynamic performance control 108 to adjust other features that are less important to the user while preserving features that are more important to the user. For example in a video call, audio quality tends to be a more important feature than if the video has some jitter or lower resolution, but users' preferences can differ.

Another feature of learning service 110 is that it can detect when adjustments have been made to one or more configurable features of the application that conflict with the user's preferences and can instruct the dynamic performance control to recover the configurable features that are important according to the user preferences.

Additionally, the learning service 110 is configured to learn correlations between adjustments to one or more configurable features of the application and the resulting effects on the device health and application runtime health. This learning is specific to the particular application and device on which it is running and can be used to identify when certain changes that might be expected to achieve the desired improvement in resource utilization are not as effective as they are expected to be as each device and runtime environment is different. In such situations, learning service 110 can inform the dynamic performance control 108 of observed correlations between application configurations and resource utilization to improve the dynamic performance control 108. The learning service 110 can also recover previous settings when dynamic performance control 108 attempts changes in configurations that are not effective on the client device, and causes the dynamic performance control to try alternate configurations of the application that are expected to be more effective on the particular application 104 and the client device on which it's executing.

Relationships learned by learning service 110 can also be provided to the static performance control 106 so that the static performance control 106 can continue to learn based on this updated data. In this way, the algorithm provided by the static performance control 106 can improve over time, and the dynamic performance control 108 and associated learning service 110 can continue to function to provide performance and resource optimization that is tuned to the particularities of the application running on the client device and the user of the application.

The distributed intelligence model illustrated in FIG. 1 wherein the static performance control can provide high-quality initial application configurations based on learned correlations from a large dataset, coupled with application-device level intelligence and learning provides improved performance and resource optimization for the application and the device on which it is executing and provides a better user experience since the user's preferences for the performance of the application, and the user's tolerance for high amounts of resource utilization are taken into account.

FIG. 2 illustrates an example of correlations derived by the static performance control 106 in the example of a video meeting application. In particular, FIG. 2 illustrates that data reflecting changes in configurable attributes of the application being correlated to changes in device health and the application runtime health statistics and a convergence time, which represents a time for the device health and the application runtime health statistics to return to an acceptable level after a configuration change.

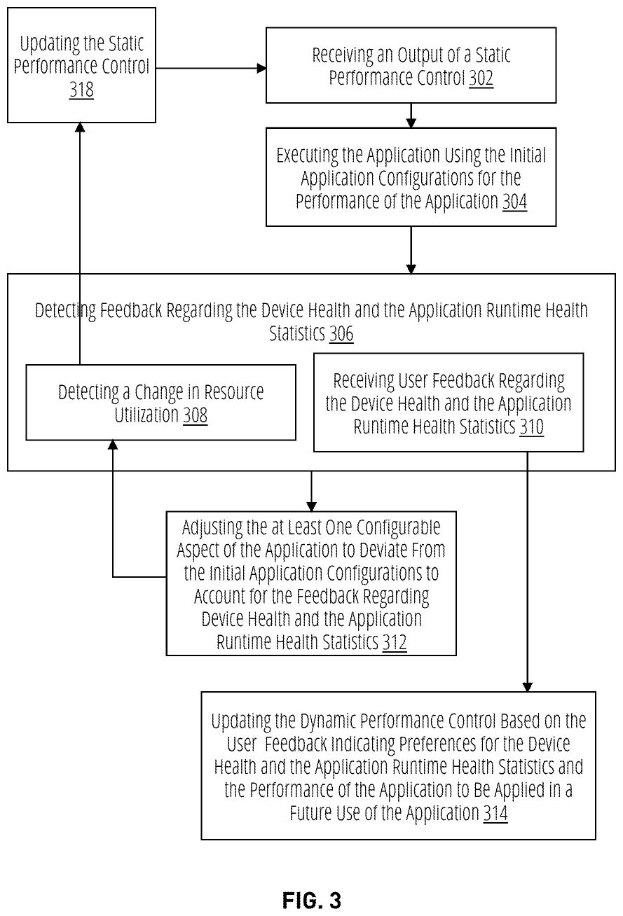

FIG. 3 illustrates an example routine for using a static performance control combined with a dynamic performance control to provide performance and resource optimization in accordance with some aspects of the present technology. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes receiving an output of a static performance control at block 302. For example, the application 104 illustrated in FIG. 1 may receive an output of a static performance control. The output of the static performance control is initial application configurations for at least one configurable aspect of the application. As addressed above, the static performance control the static performance control includes a cloud-based machine learning algorithm trained on a large data set comprised of information about client devices running an application and application configurations on respective client devices. Accordingly, the initial application configurations are configurations that are expected to provide quality performance and resource optimization the application 104 executing on a client device with its particular device attributes.

In some embodiments, the static performance control 106 can also output a baseline model for the dynamic performance control 108 to utilize locally and dynamically to perform performance and resource optimization in response to changing device health and the application runtime health statistics. However, as addressed in greater detail herein, the baseline model utilized by the dynamic performance control can be subject to feedback from the learning service 110 to provide some of the benefits of the present technology such as improved performance and resource optimization for the application and the device on which it is executing and a better user experience since the user's preferences for the performance of the application, and the user's tolerance for amounts of resource utilization are taken into account.

According to some examples, the method includes executing the application using the initial application configurations for the performance of the application at block 304. In particular, the application can run on the client device using the initial application configurations provided by the static performance control 106 and can react to changes in device health and the application runtime health statistics using a baseline model provided by the static performance control.

According to some examples, the method includes detecting feedback regarding the device health and the application runtime health statistics at block 306. For example, the dynamic performance control 108 illustrated in FIG. 1 may detect feedback regarding the device health and the application runtime health statistics. The feedback can come in at least two varieties.

In one variety of the feedback, the dynamic performance control 108 may detect a change in device health and the application runtime health statistics as illustrated at block 308. The dynamic performance control 108 can interface with a device system monitor to learn information about the processor utilization, memory utilization, power consumption and other device components, and can receive reports from the application 104 regarding the application health statistics.

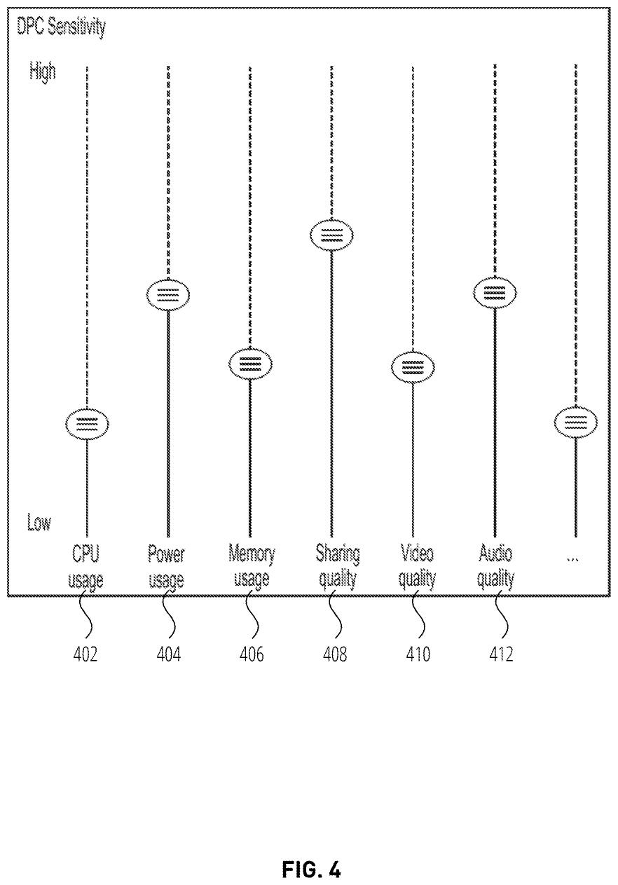

In another variety of the feedback, the dynamic performance control 108 includes receiving user feedback regarding the device health and the application runtime health statistics at block 310. FIG. 4 illustrates an example of a user interface that can be provided to receive user feedback regarding their preferences for the device health and the application runtime health statistics. The user interface illustrated in FIG. 4 can be for an example video meeting application where a user can provide their relative preferences regarding how important attributes such as CPU usage 402, Power usage 404, Memory usage 406, Sharing quality 408 (quality of outgoing audio or video), Video quality 410 (quality of incoming video measured in resolution, frame rate, jitter, etc.), Audio quality 412 (quality of incoming audio measured in bit rate, packet loss, etc.), etc. are to the user.

As addressed above the dynamic performance control runs on client device with the application and can be utilized to dynamically respond to changes in the device health and the application runtime health statistics to keep the application and device functioning well in order to provide a good user experience. In some embodiments, the dynamic performance control executes a performance and resource optimization algorithm provided by a machine learning algorithm. In some embodiments, the performance and resource optimization algorithm of the dynamic performance control is generated at the datacenter 102, and in some embodiments, the performance and resource optimization algorithm of the dynamic performance control is generated at the client device.

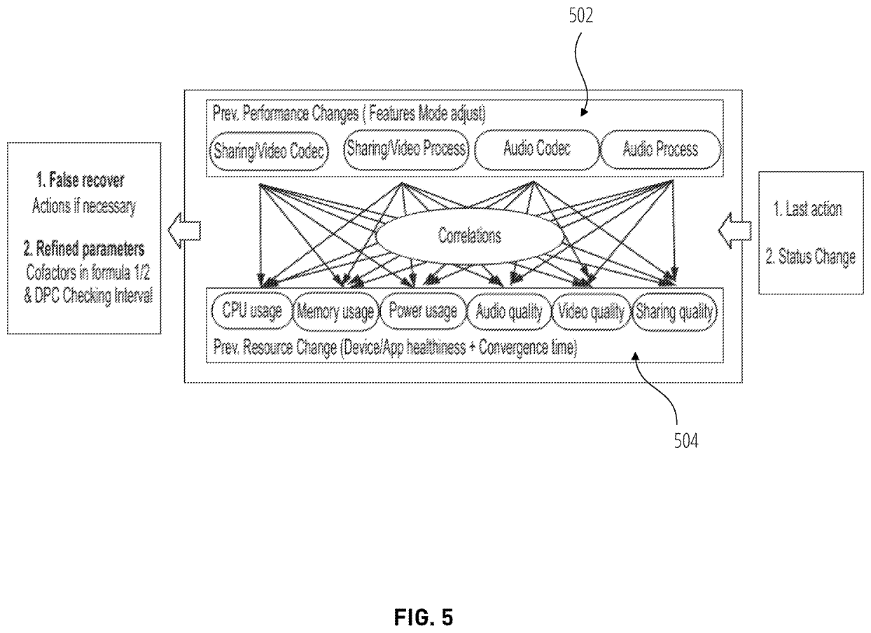

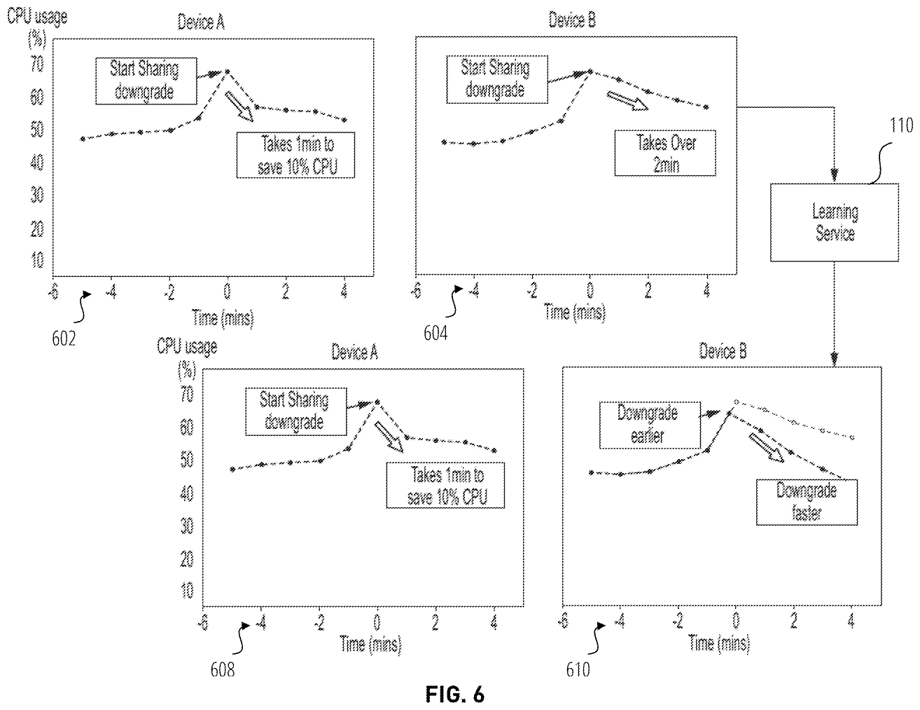

While illustrated as a separate service in FIG. 1, the learning service 110 can be part of the dynamic performance control 108 or can at least interact with the dynamic performance control 108. The learning service 110 can learn from the user preferences indicated by the user using an interface such as that illustrated in FIG. 4 and can learn about correlations between adjustments to one or more configurable features of the application and the resulting effects on the device health and application runtime health. This learning is specific to the particular application and device on which it is running. FIG. 5 and FIG. 6 illustrate aspects of the learning service 110 learning about correlations between adjustments to one or more configurable features of the application and the resulting effects on the device health and application runtime health.

The learnings by the learning service 110 can be used to improve the adjustments made by the dynamic performance control 108 or used to constrain or revise adjustments made by the dynamic performance control 108.

According to some examples, the method includes adjusting the at least one configurable aspect of the application to deviate from the initial application configurations to account for the feedback regarding device health and the application runtime health statistics at block 312. For example, the application 104 illustrated in FIG. 1 may adjust the at least one configurable aspect of the application to deviate from the initial application configurations to account for the feedback regarding device health and the application runtime health statistics.

The application can make these adjustments as instructed by the dynamic performance control 108 and/or the learning service 110. The adjustments are made for performance and resource optimization to maintain good performance of the application 104 and the client device as conditions on the client device change. The adjustments are also made in accordance with the user's preferences.

Often, adjustments that result in a higher-quality performance of the application or the use of more features of the application can be correlated to an increase in device resource utilization, and adjustments that result in lower-quality performance or the use of fewer features of the application result in a decrease in device resource utilization.

In situations in which the dynamic performance control 108 instructs an adjustment that learning service 110 has learned is not desirable, the learning service 110 can also recover previous settings. For example, when dynamic performance control 108 attempts changes in configurations that are not effective on the client device, the learning service 110 causes the dynamic performance control to try alternate configurations of the application that are expected to be more effective on the particular application 104 and the client device on which it's executing. In another example, when dynamic performance control 108 attempts adjustments that conflict with the user's preferences the learning service 110 can instruct the dynamic performance control to try alternate configurations of the application that are in line with the user's preferences.

While the dynamic performance control 108 and learning service 110 have been discussed as separate entities, these can be combined into a single service too.

According to some examples, the method includes updating the dynamic performance control based on the user feedback indicating preferences for the device health and the application runtime health statistics to be applied in a future use of the application at block 314. For example, the application 104 illustrated in FIG. 1 may update the dynamic performance control based on the user feedback indicating preferences for the device health and the application runtime health statistics.

Similarly, relationships learned by learning service 110 can also be provided to the static performance control 106 so that the static performance control 106 can continue to learn based on this updated data at block 318. For example, the dynamic performance control 108 illustrated in FIG. 1 may update the static performance control. In this way, the algorithm provided by the static performance control 106 can improve over time, and the dynamic performance control 108 and associated learning service 110 can continue to function to provide performance and resource optimization that is tuned to the particularities of the application running on the client device and the user of the application.

FIG. 4 illustrates an example of a user interface that can be provided to receive user feedback regarding their preferences for the device health and the application runtime health statistics in accordance with some aspects of the present technology. The user interface illustrated in FIG. 4 can be, for example, a video meeting application where a user can provide their relative preferences regarding how important attributes such as CPU usage 402, Power usage 404, Memory usage 406, Sharing quality 408 (quality of outgoing audio or video), Video quality 410 (quality of incoming video measured in resolution, frame rate, jitter, etc.), Audio quality 412 (quality of incoming audio measured in bit rate, packet loss, etc.), etc. are to the user.

It will be appreciated that the user interface illustrated in FIG. 4 is for example purposes only and the present technology can apply to other user interface designs. Additionally, the present technology can apply to many types of applications that might have different attributes for which a user can provide their preferences. And even when the application is a video meeting application, the present technology applies to support additional attributes that are not illustrated in FIG. 4.

In some embodiments, an interface such as illustrated in FIG. 4 might not be needed in order for the learning service 110 to learn a user's preferences. In some embodiments, the learning service 110 may be able to infer the user's preferences from other user actions, or from user satisfaction surveys provided to the user.

FIG. 5 illustrates an example of a function of the learning service 110 in accordance with some aspects of the present technology.

The learning service 110 can monitor current and adjusted application configurations 502, and the resulting changes in measurements of device health and the application runtime health statistics 504 to observe a convergence time, which represents a time for the device health and the application runtime health statistics to return to an acceptable level after a configuration change. The learning service 110 can learn from this data to draw correlations as to what changes in application configurations 502 are effective to result in desired device health and the application runtime health statistics 504.

As addressed above, the learning service 110 can use such learning to take false recover actions, which are actions to roll back changes in application configurations 502 that are not expected (or fail) to achieve the desired device health and the application runtime health statistics 504.

FIG. 6 illustrates graphs showing a benefit of the learning service in accordance with some aspects of the present technology.

In the first graph 602 the application on Device A created an increase in device health and the application runtime health statistics as a result of sharing video with other meeting participants, and the dynamic performance control caused an adjustment in one or more configurable attributes of the application. In the second graph 604 the application on Device B created the same increase in device health and the application runtime health statistics as a result of sharing video with other meeting participants and the dynamic performance control caused the same adjustment in one or more configurable attributes of the application, just as occurred in Device A. However, normalization of the device health and the application runtime health statistics took twice as long as was less effective on Device B compared to Device A. This demonstrates the problem with a single model created to work on all devices. Each device and runtime environment can be different so the same changes on one device might not be as effective on another device.

The learning service 110 helps to solve this problem by learning what adjustments can be made to result in a faster normalization of device health and the application runtime health statistics and a more effective solution too.

Graph 608 is the same graph as graph 602 demonstrating the same compensation video sharing on Device A. But Graph 610 demonstrates the effect of the learning by the learning service 110. In graph 610 the dynamic performance control/learning service 110 reacted more quickly to adjust one or more configurable attributes in response to the video sharing, and the adjustments that were made were more effective. Graph 610 shows that Device B was able to normalize its device health and the application runtime health statistics more quickly than before the learning as shown in graph 604, and that the reduction in CPU usage was greater (graph 604 achieved 60% CPU usage, while graph 610 achieved 40% CUP usage).

Accordingly, the application-device level intelligence and learning by learning service 110 provides improved performance and resource optimization for the application and the specific device on which it is executing and provides a better user experience since the user's preferences for the performance of the application, and the user's tolerance for high amounts of resource utilization are taken into account.

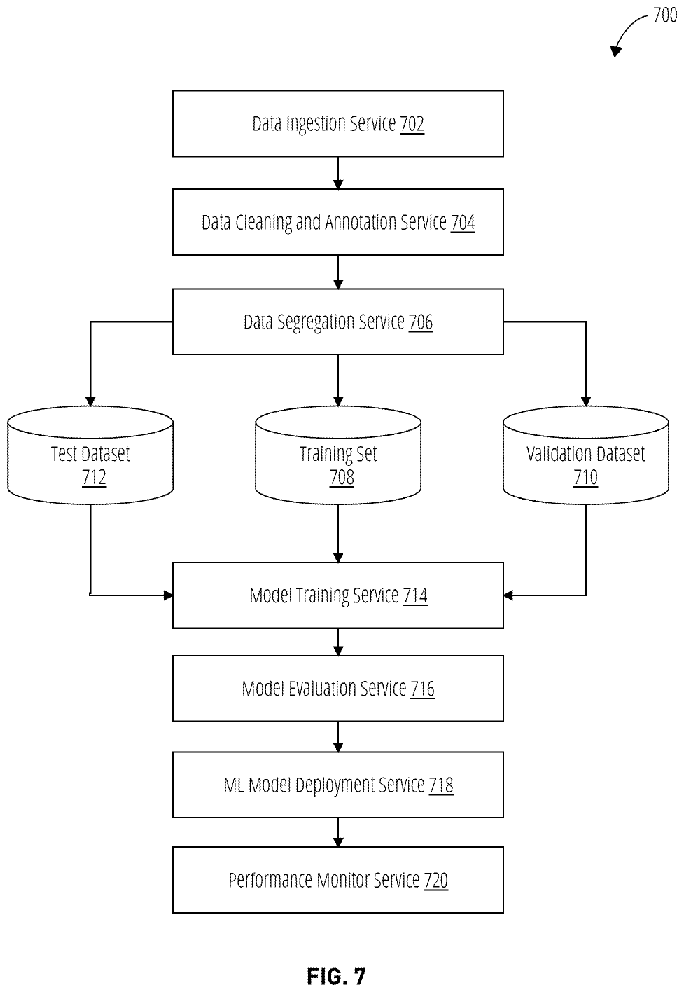

FIG. 7 illustrates an example lifecycle 700 of a ML model in accordance with some aspects of the present technology. The first stage of the lifecycle 700 of a ML model is a data ingestion service 702 to generate datasets described below. ML models require a significant amount of data for the various processes described in FIG. 7 and the data persisted without undertaking any transformation to have an immutable record of the original dataset. The data can be provided from third party sources such as publicly available dedicated datasets. The data ingestion service 702 provides a service that allows for efficient querying and end-to-end data lineage and traceability based on a dedicated pipeline for each dataset, data partitioning to take advantage of the multiple servers or cores, and spreading the data across multiple pipelines to reduce the overall time to reduce data retrieval functions.

In some cases, the data may be retrieved offline that decouples the producer of the data from the consumer of the data (e.g., an ML model training pipeline). For offline data production, when source data is available from the producer, the producer publishes a message and the data ingestion service 702 retrieves the data. In some examples, the data ingestion service 702 may be online and the data is streamed from the producer in real-time for storage in the data ingestion service 702.

After data ingestion service 702, a data preprocessing service preprocesses the data to prepare the data for use in the lifecycle 700 and includes at least data cleaning, data transformation, and data selection operations. The data cleaning and annotation service 704 removes irrelevant data (data cleaning) and general preprocessing to transform the data into a usable form. The data cleaning and annotation service 704 includes labelling of features relevant to the ML model. In some examples, the data cleaning and annotation service 704 may be a semi-supervised process performed by a ML to clean and annotate data that is complemented with manual operations such as labeling of error scenarios, identification of untrained features, etc.

After the data cleaning and annotation service 704, data segregation service 706 to separate data into at least a training set 708, a validation dataset 710, and a test dataset 712. Each of the training set 708, a validation dataset 710, and a test dataset 712 are distinct and do not include any common data to ensure that evaluation of the ML model is isolated from the training of the ML model.

The training set 708 is provided to a model training service 714 that uses a supervisor to perform the training, or the initial fitting of parameters (e.g., weights of connections between neurons in artificial neural networks) of the ML model. The model training service 714 trains the ML model based a gradient descent or stochastic gradient descent to fit the ML model based on an input vector (or scalar) and a corresponding output vector (or scalar).

After training, the ML model is evaluated at a model evaluation service 716 using data from the validation dataset 710 and different evaluators to tune the hyperparameters of the ML model. The predictive performance of the ML model is evaluated based on predictions on the validation dataset 710 and iteratively tunes the hyperparameters based on the different evaluators until a best fit for the ML model is identified. After the best fit is identified, the test dataset 712, or holdout data set, is used as a final check to perform an unbiased measurement on the performance of the final ML model by the model evaluation service 716. In some cases, the final dataset that is used for the final unbiased measurement can be referred to as the validation dataset and the dataset used for hyperparameter tuning can be referred to as the test dataset.

After the ML model has been evaluated by the model evaluation service 716, an ML model deployment service 718 can deploy the ML model into an application or a suitable device. The deployment can be into a further test environment such as a simulation environment, or into another controlled environment to further test the ML model.

After deployment by the ML model deployment service 718, a performance monitor service 720 monitors for performance of the ML model. In some cases, the performance monitor service 720 can also record additional transaction data that can be ingested via the data ingestion service 702 to provide further data, additional scenarios, and further enhance the training of ML models.

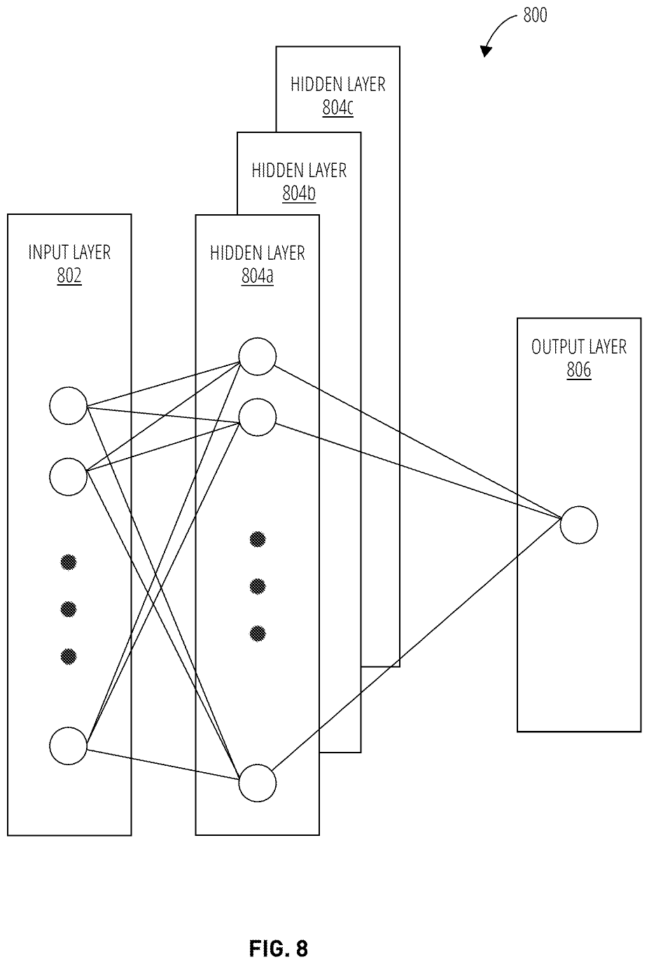

In FIG. 8, the disclosure now turns to a further discussion of models that can be used through the environments and techniques described herein. Specifically, FIG. 8 is an illustrative example of a deep learning neural network 800 that can be used to implement all or a portion of a perception module (or perception system) as discussed above. An input layer 802 can be configured to receive sensor data and/or data relating to an environment surrounding an AV. The neural network 800 includes multiple hidden layers 804a, 804b, through 804c. The hidden layers 804a through 804c include “n” number of hidden layers, where “n” is an integer greater than or equal to one. The number of hidden layers can be made to include as many layers as needed for the given application. The neural network 800 further includes an output layer 806 that provides an output resulting from the processing performed by the hidden layers 804a through 804c. In one illustrative example, the output layer 806 can provide estimated treatment parameters, that can be used/ingested by a differential simulator to estimate a patient treatment outcome.

The neural network 800 is a multi-layer neural network of interconnected nodes. Each node can represent a piece of information. Information associated with the nodes is shared among the different layers and each layer retains information as information is processed. In some cases, the neural network 800 can include a feed-forward network, in which case there are no feedback connections where outputs of the network are fed back into itself. In some cases, the neural network 800 can include a recurrent neural network, which can have loops that allow information to be carried across nodes while reading in input.

Information can be exchanged between nodes through node-to-node interconnections between the various layers. Nodes of the input layer 802 can activate a set of nodes in the first hidden layer 804a. For example, as shown, each of the input nodes of the input layer 802 is connected to each of the nodes of the first hidden layer 804a. The nodes of the first hidden layer 804a can transform the information of each input node by applying activation functions to the input node information. The information derived from the transformation can then be passed to and can activate the nodes of the next hidden layer 804b, which can perform their own designated functions. Example functions include convolutional, up-sampling, data transformation, and/or any other suitable functions. The output of the hidden layer 804b can then activate nodes of the next hidden layer, and so on. The output of the last hidden layer 804c can activate one or more nodes of the output layer 806, at which an output is provided. In some cases, while nodes in the neural network 800 are shown as having multiple output lines, a node can have a single output and all lines shown as being output from a node represent the same output value.

In some cases, each node or interconnection between nodes can have a weight that is a set of parameters derived from the training of the neural network 800. Once the neural network 800 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 800 to be adaptive to inputs and able to learn as more and more data is processed.

The neural network 800 is pre-trained to process the features from the data in the input layer 802 using the different hidden layers 804a through 804c in order to provide the output through the output layer 806.

In some cases, the neural network 800 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 800 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 800 can perform a backward pass by determining which inputs (weights) most contributed to the loss of the network, and can adjust the weights so that the loss decreases and is eventually minimized.

The neural network 800 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 800 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

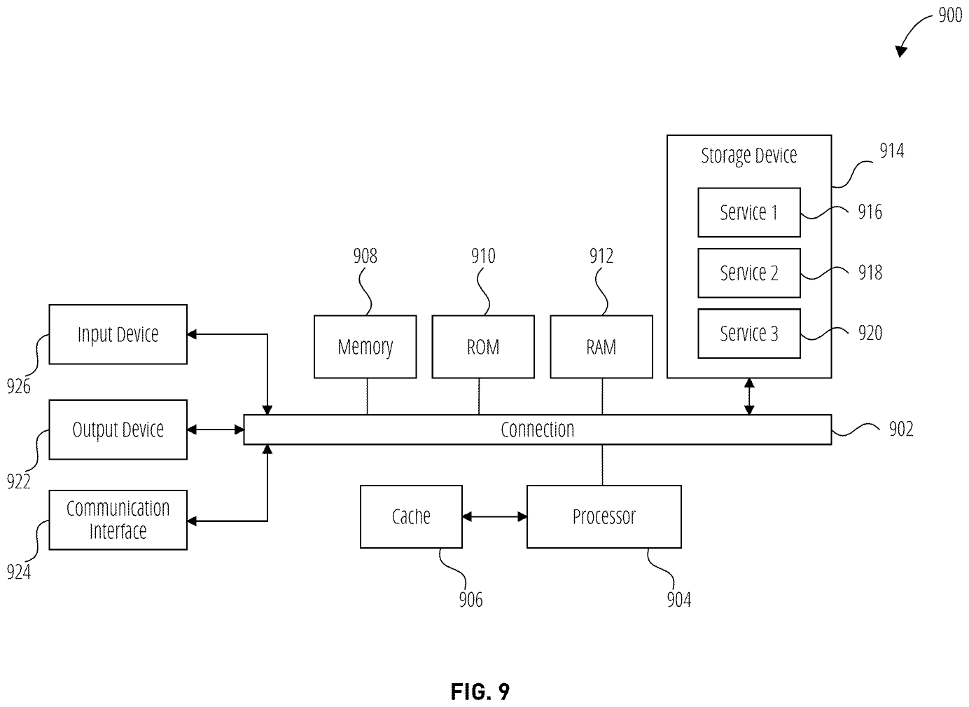

FIG. 9 shows an example of computing system 900, which can be for example any computing device making up static performance control 106, dynamic performance control 108 learning service 110, application 104, or any component thereof in which the components of the system are in communication with each other using connection 902. Connection 902 can be a physical connection via a bus, or a direct connection into processor 904, such as in a chipset architecture. Connection 902 can also be a virtual connection, networked connection, or logical connection.

In some embodiments, computing system 900 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 900 includes at least one processing unit (CPU or processor) 904 and connection 902 that couples various system components including system memory 908, such as read-only memory (ROM) 910 and random access memory (RAM) 912 to processor 904. Computing system 900 can include a cache of high-speed memory 906 connected directly with, in close proximity to, or integrated as part of processor 904.

Processor 904 can include any general purpose processor and a hardware service or software service, such as services 916, 918, and 920 stored in storage device 914, configured to control processor 904 as well as a special-purpose processor where software instructions are incorporated into the actual processor design. Processor 904 may essentially be a completely self-contained computing system, containing multiple cores or processors, a bus, memory controller, cache, etc. A multi-core processor may be symmetric or asymmetric.

To enable user interaction, computing system 900 includes an input device 926, which can represent any number of input mechanisms, such as a microphone for speech, a touch-sensitive screen for gesture or graphical input, keyboard, mouse, motion input, speech, etc. Computing system 900 can also include output device 922, which can be one or more of a number of output mechanisms known to those of skill in the art. In some instances, multimodal systems can enable a user to provide multiple types of input/output to communicate with computing system 900. Computing system 900 can include communication interface 924, which can generally govern and manage the user input and system output. There is no restriction on operating on any particular hardware arrangement, and therefore the basic features here may easily be substituted for improved hardware or firmware arrangements as they are developed.

Storage device 914 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 914 can include software services, servers, services, etc., that when the code that defines such software is executed by the processor 904, it causes the system to perform a function. In some embodiments, a hardware service that performs a particular function can include the software component stored in a computer-readable medium in connection with the necessary hardware components, such as processor 904, connection 902, output device 922, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

The present technology includes computer-readable storage mediums for storing instructions, and systems for executing any one of the methods embodied in the instructions addressed in the aspects of the present technology presented below:

Aspect 1. A method for using a static performance control combined with a dynamic performance control to balance performance of an application with device health and the application runtime health statistics, the method comprising: receiving, by the application, an output of a static performance control, wherein the output of the static performance control is initial application configurations for at least one configurable aspect of the application, wherein the application is a multi-media application, wherein configurable aspects of the multi-media application include video configurations, video processing options, audio configurations, audio processing options; executing, by a client device, the application using the initial application configurations for the performance of the application; detecting, by the dynamic performance control, feedback regarding the device health and the application runtime health statistics; and adjusting, by the application, the at least one configurable aspect of the application to deviate from the initial application configurations to account for the feedback regarding device health and the application runtime health statistics.

Aspect 2. The method of Aspect 1, further comprising: receiving user feedback by the dynamic performance control regarding the device health and the application runtime health statistics, the user feedback indicating preferences for the device health and the application runtime health statistics and the performance of the application, wherein the user feedback is the feedback regarding the device health and the application runtime health statistics.

Aspect 3. The method of any of Aspects 1 to 2, further comprising: updating, by the application, the dynamic performance control based on the user feedback indicating preferences for the device health and the application runtime health statistics and the performance of the application to be applied in a future use of the application.

Aspect 4. The method of any of Aspects 1 to 3, wherein an adjusting the at least one configurable aspect of the application is to meet the user feedback indicating preferences for the device health and the application runtime health statistics and the performance of the application, wherein greater performance of the application can be correlated to an increase in device health and the application runtime health statistics, and reduced performance of the application can be correlated to a decrease in device health and the application runtime health statistics.

Aspect 5. The method of any of Aspects 1 to 4, wherein the dynamic performance control includes a machine learning algorithm.

Aspect 6. The method of any of Aspects 1 to 5, wherein the dynamic performance control runs on client device with the application.

Aspect 7. The method of any of Aspects 1 to 6, further comprising: detecting a change in resource utilization by the dynamic performance control, wherein the change in the resource utilization is the feedback regarding the device health and the application runtime health statistics.

Aspect 8. The method of any of Aspects 1 to 7, wherein the adjusting the at least one configurable aspect of the application is to select a reduced performance parameter of the at least one configurable aspect of the application which is correlated to a reduction in device health and the application runtime health statistics.

Aspect 9. The method of any of Aspects 1 to 8, wherein the static performance control includes a cloud-based machine learning algorithm.

What is claimed is:

1. A method comprising:
receiving, by an application, an output of a static performance control, wherein the output of the static performance control is initial application configurations for at least one configurable aspect of the application;
executing, by a client device, the application using the initial application configurations for the performance of the application;
detecting, by a dynamic performance control, feedback regarding device health and application runtime health statistics; and
adjusting, by the application, the at least one configurable aspect of the application to deviate from the initial application configurations to account for the feedback regarding the device health and the application runtime health statistics.

2. The method of claim 1, further comprising:
receiving user feedback by the dynamic performance control regarding the device health and the application runtime health statistics, the user feedback indicating preferences for the device health and the application runtime health statistics and the performance of the application, wherein the user feedback is the feedback regarding the device health and the application runtime health statistics.

3. The method of claim 1, receiving feedback from a learning service indicating that the adjusting of the at least one configurable aspect of the application will not be effective on the client device and recover the initial application configurations.

4. The method of claim 1, wherein the static performance control includes a cloud-based machine learning algorithm, and wherein the dynamic performance control includes a machine learning algorithm on the client device.

5. The method of claim 2, further comprising:
updating, by the application, the dynamic performance control based on the user feedback indicating preferences for the device health and the application runtime health statistics and the performance of the application to be applied in a future use of the application.

6. The method of claim 5, wherein an adjusting the at least one configurable aspect of the application is to meet the user feedback indicating preferences for the device health and the application runtime health statistics and the performance of the application.

7. The method of claim 1, wherein the adjusting the at least one configurable aspect of the application is to select a reduced performance parameter of the at least one configurable aspect of the application which is correlated to a reduction in device health and the application runtime health statistics.

8. A computing system comprising:
a processor; and
a memory storing instructions that, when executed by the processor, configure the system to:
receive, by an application, an output of a static performance control, wherein the output of the static performance control is initial application configurations for at least one configurable aspect of the application;
execute, by a client device, the application using the initial application configurations for the performance of the application;
detect, by a dynamic performance control, feedback regarding device health and application runtime health statistics; and
adjust, by the application, the at least one configurable aspect of the application to deviate from the initial application configurations to account for the feedback regarding the device health and the application runtime health statistics.

9. The computing system of claim 8, wherein the instructions further configure the system to:
receive user feedback by the dynamic performance control regarding the device health and the application runtime health statistics, the user feedback indicating preferences for the device health and the application runtime health statistics and the performance of the application, wherein the user feedback is the feedback regarding the device health and the application runtime health statistics.

10. The computing system of claim 8, receive feedback from a learning service indicating that the adjusting of the at least one configurable aspect of the application will not be effective on the client device and recover the initial application configurations.

11. The computing system of claim 8, wherein the static performance control includes a cloud-based machine learn algorithm, and wherein the dynamic performance control includes a machine learning algorithm on the client device.

12. The computing system of claim 9, wherein the instructions further configure the system to:
update, by the application, the dynamic performance control based on the user feedback indicating preferences for the device health and the application runtime health statistics and the performance of the application to be applied in a future use of the application.

13. The computing system of claim 12, wherein an adjusting the at least one configurable aspect of the application is to meet the user feedback indicate preferences for the device health and the application runtime health statistics and the performance of the application.

14. The computing system of claim 8, wherein the adjusting the at least one configurable aspect of the application is to select a reduced performance parameter of the at least one configurable aspect of the application which is correlated to a reduction in device health and the application runtime health statistics.

15. A non-transitory computer-readable storage medium, the computer-readable storage medium including instructions that when executed by at least one processor, cause the at least one processor to:
receive, by an application, an output of a static performance control, wherein the output of the static performance control is initial application configurations for at least one configurable aspect of the application;
execute, by a client device, the application using the initial application configurations for the performance of the application;
detect, by a dynamic performance control, feedback regarding device health and application runtime health statistics; and
adjust, by the application, the at least one configurable aspect of the application to deviate from the initial application configurations to account for the feedback regarding the device health and the application runtime health statistics.

16. The computer-readable storage medium of claim 15, wherein the instructions further configure the at least one processor to:
receive user feedback by the dynamic performance control regarding the device health and the application runtime health statistics, the user feedback indicating preferences for the device health and the application runtime health statistics and the performance of the application, wherein the user feedback is the feedback regarding the device health and the application runtime health statistics.

17. The computer-readable storage medium of claim 15, receive feedback from a learning service indicating that the adjusting of the at least one configurable aspect of the application will not be effective on the client device and recover the initial application configurations.

18. The computer-readable storage medium of claim 15, wherein the static performance control includes a cloud-based machine learn algorithm, and wherein the dynamic performance control includes a machine learning algorithm on the client device.

19. The computer-readable storage medium of claim 16, wherein the instructions further configure the at least one processor to:
update, by the application, the dynamic performance control based on the user feedback indicating preferences for the device health and the application runtime health statistics and the performance of the application to be applied in a future use of the application.

20. The computer-readable storage medium of claim 19, wherein an adjusting the at least one configurable aspect of the application is to meet the user feedback indicate preferences for the device health and the application runtime health statistics and the performance of the application.
